(19) United States
(12) Patent Application Publication
(10) Pub. No.: US 2025/0258666 A1
(43) Pub. Date: Aug. 14, 2025

(54) FIRMWARE UPGRADE METHOD FOR EMBEDDED COMBINATION APPARATUS AND FIRMWARE UPGRADE DEVICE THEREOF

(71) Applicant: QISDA (SUZHOU) CO., Ltd., Suzhou (CN)

(72) Inventor: Song Hua, Suzhou (CN)

(73) Assignee: QISDA (SUZHOU) CO., Ltd., Suzhou (CN)

(21) Appl. No.: 19/010,181

(22) Filed: Jan. 6, 2025

(30) Foreign Application Priority Data
Feb. 8, 2024 (CN) 202410176137.6

(51) Int. Cl. G06F 8/654; G06F 8/658; H04L 67/00

(52) U.S. Cl. CPC G06F 8/654; G06F 8/658; H04L 67/34

(57) ABSTRACT

The present invention provides a firmware upgrade method and a firmware upgrade device thereof for an embedded combination apparatus. A main device is first connected to a computer for firmware upgrade, and then a firmware version of a slave device is checked to determine whether to match a firmware version of the main device. If they match, the slave device does not need to be upgraded. If any slave device has a mismatched firmware version, the main device sends an upgrade command and data of a matching firmware version to the slave device individually. The slave device receives a corresponding firmware upgrade package for firmware upgrade. The firmware upgrade method of the present invention complete a firmware upgrade process of the embedded combination apparatus without detaching the main device from the slave device, which is convenient and fast with a lower error rate.

### BACKGROUND OF THE INVENTION

### 1. Field of the Invention

The present invention relates to an embedded combination apparatus, and more specifically, to a firmware upgrade method for an embedded combination apparatus and a firmware upgrade device thereof.

### 2. Description of the Prior Art

An embedded combination apparatus generally consists of a main device and one or more slave devices, which are connected via USB or serial port cables. Firmware upgrades during the lifecycle of the embedded combination apparatus are performed on the main device and the slave device separately. For example, in a combination apparatus like a tablet computer and a docking station, the tablet computer and the docking station need to be detached from each other first if a firmware upgrade process needs to be performed. Subsequently, the tablet computer is upgraded by OTA technology (Over the Air Technology), or is coupled to a PC (Personal Computer) via a data cable and upgraded via a specific software executed by the PC. The docking station is also coupled to the PC via the data cable and upgraded by the PC. During the aforesaid firmware upgrade process, the main device and the slave device do not communicate with each other, and firmware version numbers of the main device and the slave device are only known when the main device is reassembled with the slave device and restarts again.

Current firmware upgrades for the embedded combination apparatus are performed separately. Sometimes the embedded combination apparatus needs to be disassembled and coupled to the PC via the data cable for firmware burning and assembly of the embedded combination apparatus is then performed after the firmware upgrade process is completed, which is strenuous and time-consuming. For avoiding firmware incompatibility between combined devices of the embedded combination apparatus, an operator needs to know the firmware version compatibility of each combined device and manually selects an appropriate firmware version for each combined device before the aforesaid firmware upgrade process is performed, thereby increasing the error rate of the firmware upgrade process.

### SUMMARY OF THE INVENTION

The present invention provides a firmware upgrade method and a firmware upgrade device thereof for an embedded combination apparatus, for solving the prior art problem that the embedded combination apparatus needs to be disassembled and then performs firmware upgrades on the combined devices in the embedded combination apparatus separately checking after the firmware version compatibility.

For achieving the aforesaid purpose, the present invention adopts the following technical solutions.

A firmware upgrade method for an embedded combination apparatus is disclosed. The embedded combination apparatus includes a main device and a slave device. The slave device is coupled to the main device. The firmware upgrade method includes:
Step S1: connecting the main device to a computer to receive a first firmware upgrade package for upgrading a firmware of the main device and restarting the main device, wherein the first firmware upgrade package includes a second firmware upgrade package for upgrading the slave device;
Step S2: the main device reading a firmware version information of the slave device;
Step S3: comparing a firmware version information of the main device with the firmware version information of the slave device to determine whether the slave device needs to be upgraded;
Step S4: if it is determined that the slave device needs to be upgraded, the main device sending an upgrade command and the second firmware upgrade package to the slave device; and
Step S5: the slave device receiving the upgrade command and the second firmware upgrade package to upgrade a firmware of the slave device and restart according to the upgrade command.

Preferably, after Step S3 is completed, if it is determined that the slave device does not need to be upgraded, Step S4 and Step S5 are skipped, and a firmware upgrade process of the embedded combination apparatus is completed.

Preferably, connection between the main device and the computer is wireless or wired, and/or connection between the slave device and the main device is wireless or wired.

Preferably, when connection between the main device and the computer is wireless, OTA technology (Over the Air Technology) is used to receive the first firmware upgrade package in Step S1.

Preferably, the main device corresponds to at least two types of slave devices, and in Step S2, the main device determines a type of the slave device by reading a hardware ID of the slave device.

Preferably, in Step S4, the main device obtains a current firmware version number matching the slave device according to a current firmware version number of the main device, and sends a corresponding firmware version to the slave device.

A firmware upgrade device for an embedded combination apparatus is disclosed. The embedded combination apparatus includes a main device and a slave device. The slave device is coupled to the main device. The firmware upgrade device includes:
a main upgrade module connecting the main device to a computer to receive a first firmware upgrade package for upgrading a firmware of the main device and restarting the main device, wherein the first firmware upgrade package includes a second firmware upgrade package for upgrading the slave device;
a reading module utilizing the main device to read a firmware version information of the slave device;
a comparison module comparing a firmware version information of the main device with the firmware version information of the slave device to determine whether the slave device needs to be upgraded;
a sending module utilizing the main device to send an upgrade command and the second firmware upgrade package to the slave device if it is determined that the slave device needs to be upgraded; and
a slave upgrade module utilizing the slave device to receive the upgrade command and the second firmware upgrade package for upgrading a firmware of the slave device and restarting the slave device according to the upgrade command.

Preferably, connection between the main device and the computer is wireless or wired, and/or connection between the slave device and the main device is wireless or wired.

Preferably, when connection between the main device and the computer is wireless, OTA technology is used to receive the first firmware upgrade package in Step S1.

Preferably, the main device corresponds to at least two types of slave devices, and in Step S2, the main device determines a type of the slave device by reading a hardware ID of the slave device.

Compared with the prior art, the present invention has the following advantages.

When the firmware upgrade process of the embedded combination apparatus is performed, there is no need to detach the main device from the slave device, select the appropriate firmware version for each device to burn the firmware separately, and then reassemble the main device with the slave device. Instead, the main device can be directly connected to a PC for upgrading the firmware of the main device, wherein the firmware upgrade package of the main device includes the firmware upgrade package of the slave device. When the main device is running, the main device checks the firmware version of the slave device and determines whether the slave device firmware needs to be upgraded. If the slave device needs to be upgraded, the main device can directly send the upgrade command and data to the slave device for upgrading the firmware of the slave device.

The present invention can complete the firmware upgrade process of the embedded combination apparatus without networking and without separating the main device from the slave device, which is convenient and fast with low error rate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a firmware upgrade method for an embedded combination apparatus according to an embodiment of the present invention.

FIG. 2 is a diagram showing connection between the embedded combination apparatus and a computer.

FIG. 3 is a functional block diagram of a firmware upgrade device according to an embodiment of the present invention.

### DETAILED DESCRIPTION

To further understand objectives, structures, features, and functions of the present invention, the following detailed description is provided in conjunction with embodiments.

In the description of the present invention, it should be noted that terms such as “center”, “up”, “down”, “left”, “right”, “vertical”, “horizontal”, “inner”, “outer”, etc., indicate directions or positional relationships based on directions or positional relationships shown in the accompanying drawings. These terms are only for the convenience of describing the present invention and simplifying the description, and do not indicate or imply that the referred device or element must have a specific direction or be constructed and operated in a specific direction. Thus, these terms cannot be understood as limiting the present invention.

An embedded combination apparatus includes a main device 100 and one or more slave devices 200. The slave device 200 is coupled to the main device 100. When the embedded combination apparatus needs to be upgraded, the main device 100 and the slave device 200 need to be detached from each other, individually connected to a PC, and upgraded via a specific software run by the PC, and it is necessary to ensure the firmware version compatibility between the main device 100 and the slave device 200. After the aforesaid firmware upgrade process is completed, the main device 100 and the slave device 200 are combined for operation again. This process is not only strenuous and time-consuming, but also easily causes errors due to the firmware version incompatibility between the main device 100 and the slave device 200.

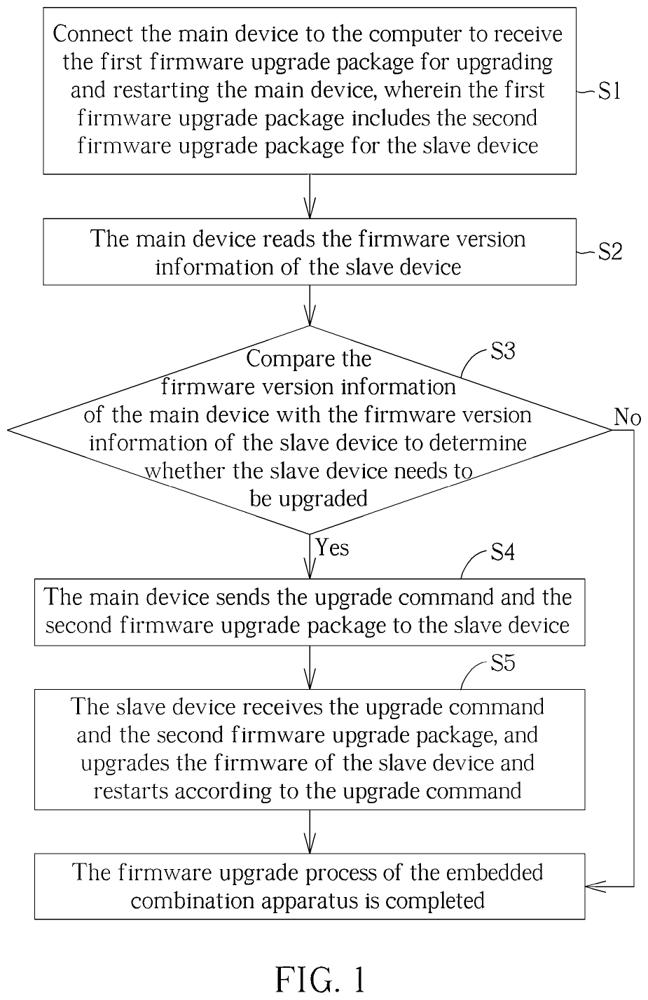

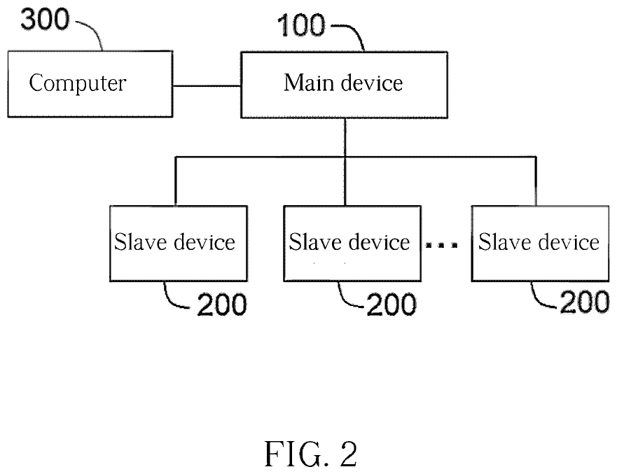

To solve the above problems, please refer to FIGS. 1 and 2. The present invention provides a firmware upgrade method for the embedded combination apparatus and a firmware upgrade device, wherein the main device 100 is responsible for the entire firmware upgrade process of the embedded combination apparatus. During the firmware upgrade process, an operator does not need to disassemble the embedded combination apparatus for performing firmware upgrades of devices in the embedded combination apparatus individually. Instead, only a firmware of the main device 100 needs to be upgraded. While running, the main device 100 checks a firmware version of the slave device 200, compares a firmware version of the main device 100 with the firmware version of the slave device 200 to determine whether a firmware of the slave device 200 needs to be upgraded. If a firmware upgrade is needed, the main device 100 sends an upgrade command and a corresponding firmware to upgrade the slave device 200.

Please refer to FIGS. 1 and 2. The present invention provides the firmware upgrade method for the embedded combination apparatus. The embedded combination apparatus includes the main device 100 and the slave device 200, wherein the slave device 200 is coupled to the main device 100 for signal communication. The firmware upgrade method includes the following steps.

Step S1: Connect the main device 100 to the computer 300 to receive a first firmware upgrade package for upgrading and restarting the main device 100, wherein the first firmware upgrade package includes a second firmware upgrade package for the slave device 200.

Step S2: The main device 100 reads a firmware version information of the slave device 200.

Step S3: Compare a firmware version information of the main device 100 with the firmware version information of the slave device 200 to determine whether the slave device 200 needs to be upgraded.

Step S4: If it is determined that the slave device 200 needs to be upgraded, the main device 100 sends the upgrade command and the second firmware upgrade package to the slave device 200.

Step S5: The slave device 200 receives the upgrade command and the second firmware upgrade package and upgrades a firmware of the slave device 200 and restarts according to the upgrade command.

After Step S3 is completed, if it is determined that the slave device 200 does not need to be upgraded, Step S4 and Step S5 are skipped, and the firmware upgrade process of the embedded combination apparatus is completed.

In this embodiment, signal connection is established between the main device 100 and the computer 300 and between the slave device 200 and the main device 100. The slave device 200 does not need to connect to the computer 300. That is, the firmware upgrade of the slave device 200 could be completed without the signal connection between the slave device 200 and the computer 300 or information transmission in a local area network where the slave device 200 is located. The firmware upgrade of the slave device 200 is entirely dependent on a signal connection channel with the main device 100. In different embodiments, the main device 100 and the computer 300 could be connected in a wireless or wired manner, and/or the slave device 200 and the main device 100 could be connected in a wireless or wired manner.

Wireless connection methods include, but are not limited thereto, one or more of WiFi modules, 2G/3G/4G/5G communication modules, Zigbee modules, and Bluetooth modules. Wired connection methods include, but are not limited thereto, one or more of USB connections, serial port connections, and other data cable connections.

When the main device 100 is wirelessly connected to the computer 300, in Step S1, OTA technology is used to receive the first firmware upgrade package and upgrade the firmware of the main device 100. Implementation methods of OTA technology could include download based on HTTP or FTP protocol, download based on Bluetooth, download based on mobile network, and download based on multicast or broadcast.

In a preferred embodiment, the main device 100 corresponds to at least two types of slave devices 200. The main device 100 is connected to one or more slave devices 200, and each slave device 200 has multiple types that can be selected according to actual needs. Furthermore, in Step S2, the main device 100 determines a type of the slave device 200 by reading a hardware ID of the slave device 200.

In one embodiment, different types of slave devices 200 are provided as follows:
a slave device 200A only has a basic configuration, and a hardware ID of the slave device 200A is 0x20000;
a slave device 200B has a display screen, and a hardware ID of the slave device 200B is 0x20001;
a slave device 200C has a display screen and a touch screen, and a hardware ID of the slave device 200C is 0x20011;
whether the last two digits of the hardware ID are 1 indicates whether a display touch function is configured.

The main device 100 could match a corresponding firmware for the slave device 200 by reading the hardware ID of the slave device 200. For example, the hardware ID 0x20001 indicates that the slave device 200 needs a firmware upgrade package corresponding to the display screen, and the hardware ID 0x20011 indicates that the slave device 200 needs a firmware upgrade package corresponding to the display screen and the touch screen.

In Step S3, the main device 100 compares the firmware version of the main device 100 with the firmware version of the slave device 200. More specifically, the main device 100 stores a matching table of the firmware versions of the main device 100 and the slave device 200 for comparing the firmware version of the slave device 200 with the current firmware version of the main device 100. If the firmware version of the slave device 200 matches the current firmware version of the main device 100, it is determined that the slave device 200 does not need to be upgraded. If the firmware version of the slave device 200 does not match the current firmware version of the main device 100, it is determined that the slave device 200 needs to be upgraded.

In Step S4, the main device 100 obtains a firmware version number of the slave device 200 based on the current firmware version number of the main device 100, and sends a corresponding upgrade firmware to the slave device 200. Since the firmware upgrade package of the main device 100 includes the firmware upgrade package of the slave device 200, the firmware upgrade of the slave device 200 could be performed after receiving the corresponding upgrade firmware.

Thus, the firmware upgrade method according to an embodiment of the present invention includes upgrading the firmware of the main device 100 first, and then checking whether the firmware version of the slave device 200 matches the upgraded firmware version of the main device 100. If the firmware version of the slave device 200 matches the upgraded firmware version of the main device 100, the slave device 200 does not need to be upgraded, and the firmware upgrade process of the embedded combination apparatus is completed. If any slave device 200 has a mismatched firmware version, the main device 100 sends the upgrade command and data of the matching firmware version to the slave device 200 individually. The slave device 200 receives the corresponding firmware upgrade package from the main device 100 and upgrades the firmware of the slave device 200, thereby completing the firmware upgrade process of the embedded combination apparatus. The firmware upgrade method of the present invention can complete the firmware upgrade process of the embedded combination apparatus without detaching the main device 100 from the slave device 200, which is convenient and fast with a lower error rate.

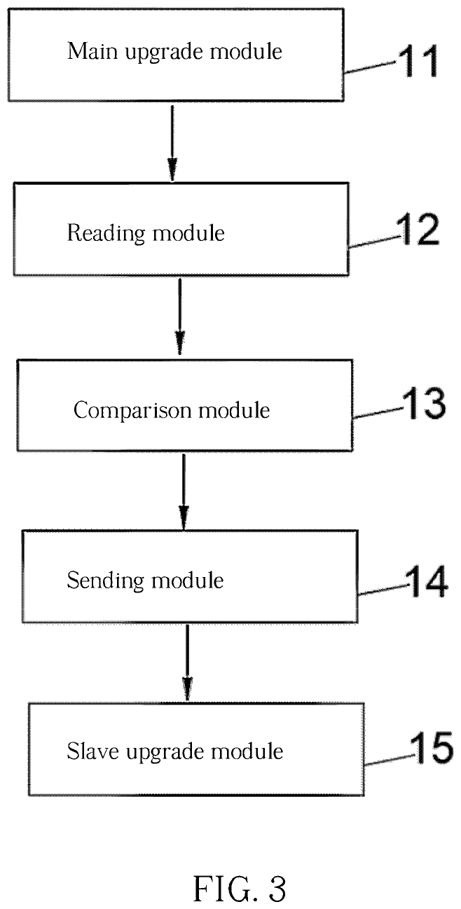

Please refer to FIG. 3. The present invention provides a firmware upgrade device for upgrading the firmware of the embedded combination apparatus. The embedded combination apparatus includes the main device 100 and the slave device 200. The slave device 200 is connected to the main device 100 for signal communication. The firmware upgrade device includes a main upgrade module 11, a reading module 12, a comparison module 13, a sending module 14, and a slave upgrade module 15.

The main upgrade module 11 connects the main device 100 to the computer 300 for receiving the first firmware upgrade package. The main device 100 upgrades the firmware of the main device 100 and restarts. The first firmware upgrade package includes the second firmware upgrade package for the slave device 200.

The reading module 12 utilizes the main device 100 to read the firmware version information of the slave device 200.

The comparison module 13 compares the firmware version information of the main device 100 with the firmware version information of the slave device 200 and determines whether the slave device 200 needs to be upgraded.

The sending module 14 sends the upgrade command and the second firmware upgrade package to the slave device 200 if it is determined that the slave device 200 needs to be upgraded.

The slave upgrade module 15 utilizes the slave device 200 to receive the upgrade command and the second firmware upgrade package for upgrading the firmware of the slave device 200 and restarts the slave device 200 according to the upgrade command.

The main upgrade module 11, the reading module 12, the comparison module 13, and the sending module 14 are disposed inside the main device 100 and connected by 12C connections, serial port connections, USB connections or other wired connections. The main device 100 and the slave device 200 are coupled through the sending module 14 and the slave upgrade module 15, which could be achieved by 12C connections, serial port connections, USB connections or other wired connections, or by WiFi wireless connections, BT wireless connections or other wireless connections.

In this embodiment, signal connection is established between the main device 100 and the computer 300 and between the slave device 200 and the main device 100. The slave device 200 does not need to connect to the computer 300. That is, the firmware upgrade of the slave device 200 could be completed without signal connection between the slave device 200 and the computer 300 or information transmission in a local area network where the slave device 200 is located. The firmware upgrade of the slave device 200 is entirely dependent on a signal connection channel with the main device 100. In different embodiments, the main device 100 and the computer 300 could be connected in a wireless or wired manner, and/or the slave device 200 and the main device 100 could be connected in a wireless or wired manner.

The wireless connection methods include, but are not limited thereto, one or more of WiFi modules, 2G/3G/4G/5G communication modules, Zigbee modules, Bluetooth modules. The wired connection methods include, but are not limited thereto, one or more of USB connections, serial port connections, and other data cable connections.

When the main device 100 is wirelessly connected to the computer 300, OTA technology is used to receive the first firmware upgrade package and upgrade the firmware of the main device 100. The implementation methods of OTA technology could include download based on HTTP or FTP protocol, download based on Bluetooth, download based on mobile network, and download based on multicast or broadcast.

In a preferred embodiment, the main device 100 corresponds to at least two types of slave devices 200. The main device 100 is connected to one or more slave devices 200, and each slave device 200 has multiple types that can be selected according to actual needs. The reading module 12 utilizes the main device 100 determines a type of the slave device 200 by reading a hardware ID of the slave device 200.

In a preferred embodiment, the comparison module 13 utilizes the main device 100 to obtain the firmware version number matching the current firmware version of the slave device 200 based on the current firmware version number of the main device 100 and send a corresponding upgrade firmware to the slave device 200.

In summary, the firmware upgrade device for upgrading the firmware of the embedded combination apparatus according to an embodiment of the present invention utilizes USB or other connection methods to achieve connection between the main device and the slave device and is not networked. In this case, the main device 100 is first connected to the computer 300 for firmware upgrade, and then the firmware version of the slave device 200 is checked to determine whether to match the upgraded firmware version of the main device 100. If the firmware version of the slave device 200 matches the upgraded firmware version of the main device 100, the slave devices 200 do not need to be upgraded, thereby completing the firmware upgrade process of the embedded combination apparatus. If any slave device 200 has a mismatched firmware version, the main device 100 sends the upgrade command and data of the matching firmware version to the slave device 200 individually. The slave device 200 receives the corresponding firmware upgrade package from the main device 100 and upgrades the firmware of the slave device 200, thereby completing the firmware upgrade process of the embedded combination apparatus. The firmware upgrade device of the present invention can complete the firmware upgrade process of the embedded combination apparatus without detaching the main device 100 from the slave device 200, which is convenient and fast with a lower error rate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A firmware upgrade method for an embedded combination apparatus, the embedded combination apparatus comprising a main device and a slave device, the slave device being coupled to the main device, the firmware upgrade method comprising:
Step S1: connecting the main device to a computer to receive a first firmware upgrade package for upgrading a firmware of the main device and restarting the main device, wherein the first firmware upgrade package comprises a second firmware upgrade package for upgrading the slave device;
Step S2: the main device reading a firmware version information of the slave device;
Step S3: comparing a firmware version information of the main device with the firmware version information of the slave device to determine whether the slave device needs to be upgraded;
Step S4: if it is determined that the slave device needs to be upgraded, the main device sending an upgrade command and the second firmware upgrade package to the slave device;
Step S5: the slave device receiving the upgrade command and the second firmware upgrade package to upgrade a firmware of the slave device and restart according to the upgrade command.

2. The firmware upgrade method of claim 1, wherein after Step S3 is completed, if it is determined that the slave device does not need to be upgraded, Step S4 and Step S5 are skipped, and a firmware upgrade process of the embedded combination apparatus is completed.

3. The firmware upgrade method of claim 1, wherein connection between the main device and the computer is wireless or wired, and/or connection between the slave device and the main device is wireless or wired.

4. The firmware upgrade method of claim 1, wherein when connection between the main device and the computer is wireless, OTA technology (Over the Air Technology) is used to receive the first firmware upgrade package in Step S1.

5. The firmware upgrade method of claim 1, wherein the main device corresponds to at least two types of slave devices, and in Step S2, the main device determines a type of the slave device by reading a hardware ID of the slave device.

6. The firmware upgrade method of claim 1, wherein in Step S4, the main device obtains a current firmware version number matching the slave device according to a current firmware version number of the main device, and sends a corresponding firmware version to the slave device.

7. A firmware upgrade device for an embedded combination apparatus, the embedded combination apparatus comprising a main device and a slave device, the slave device being coupled to the main device, the firmware upgrade device comprising:
a main upgrade module connecting the main device to a computer to receive a first firmware upgrade package for upgrading a firmware of the main device and restarting the main device, wherein the first firmware upgrade package comprises a second firmware upgrade package for upgrading the slave device;
a reading module utilizing the main device to read a firmware version information of the slave device;
a comparison module comparing a firmware version information of the main device with the firmware version information of the slave device to determine whether the slave device needs to be upgraded;
a sending module utilizing the main device to send an upgrade command and the second firmware upgrade package to the slave device if it is determined that the slave device needs to be upgraded; and
a slave upgrade module utilizing the slave device to receive the upgrade command and the second firmware upgrade package for upgrading a firmware of the slave device and restarting the slave device according to the upgrade command.

8. The firmware upgrade device of claim 7, wherein connection between the main device and the computer is wireless or wired, and/or connection between the slave device and the main device is wireless or wired.

9. The firmware upgrade device of claim 8, wherein when connection between the main device and the computer is wireless, OTA technology is used to receive the first firmware upgrade package in Step S1.

10. The firmware upgrade device of claim 7, wherein the main device corresponds to at least two types of slave devices, and in Step S2, the main device determines a type of the slave device by reading a hardware ID of the slave device.
